(19) United States
(12) Patent Application Publication
(10) Pub. No.: US 2020/0400868 A1
(43) Pub. Date: Dec. 24, 2020

(54) COLOR VISION CORRECTION LENS AND OPTICAL COMPONENT

(71) Applicant: Panasonic Intellectual Property Management Co., Ltd., Osaka (JP)

(72) Inventors: Hideki WADA, Osaka (JP); Kazuyuki YAMAE, Nara (JP); Ryosuke SHIGITANI, Osaka (JP); Yasuhisa INADA, Osaka (JP)

(21) Appl. No.: 16/897,478

(22) Filed: Jun. 10, 2020

(30) Foreign Application Priority Data
Jun. 21, 2019 (JP) 2019-115299
Oct. 28, 2019 (JP) 2019-194993

(51) Int. Cl. G02B 5/22; G02C 7/10; G02B 1/04

(52) U.S. Cl. CPC G02B 5/223; G02B 1/041; G02C 7/104

(57) ABSTRACT

A color vision correction lens that corrects color vision of a user includes: a resin layer having a first surface facing an eye of the user and a convex surface which is an example of a second surface on an opposite side of the first surface; and a reflective layer on the convex surface side of the resin layer. The resin layer contains a color material which selectively absorbs light in a first wavelength band. The reflective layer selectively reflects light in a second wavelength band. The first wavelength band and the second wavelength band overlap at least partially.

### CROSS REFERENCE TO RELATED APPLICATIONS

This application claims the benefit of priority of Japanese Patent Application Number 2019-115299, filed on Jun. 21, 2019, and Japanese Patent Application Number 2019-194993, filed on Oct. 28, 2019, the entire contents of which are hereby incorporated by reference.

### TECHNICAL FIELD

The present disclosure relates to a color vision correction lens and an optical component.

### BACKGROUND ART

Conventionally, eyeglass lenses for aiding the color differentiation ability of people with color vision deficiency have been known. For example, Japanese Unexamined Patent Application Publication No. 2002-303832 (Patent Literature (PTL) 1) describes an eyeglass lens for a person with color vision deficiency which has, on the surface of the lens, a partial reflection film having a spectral curve that monotonically increases or decreases the transmittance of a wavelength band which corresponds to a color which the person with color vision deficiency has difficulty differentiating.

### SUMMARY

### Technical Problem

However, the aforementioned conventional eyeglass lens for a person with color vision deficiency has a deeply tinted appearance, and therefore other people tend to find the appearance of the eyeglass lens somewhat odd.

In view of the above, the present disclosure aims to provide a color vision correction lens and an optical component which have a less deeply tinted appearance.

### Solution to Problem

In order to provide such a color vision correction lens and an optical component, a color vision correction lens according to an aspect of the present disclosure is a color vision correction lens that corrects color vision of a user. The color vision correction lens includes: a resin layer having a first surface facing an eye of the user and a second surface on an opposite side of the first surface; and a reflective layer on a second surface side of the resin layer. The resin layer contains a color material which selectively absorbs light in a first wavelength band, the reflective layer selectively reflects light in a second wavelength band, and the first wavelength band and the second wavelength band overlap at least partially.

In addition, an optical component according to an aspect of the present disclosure includes the color vision correction lens.

### Advantageous Effect

According to the present disclosure, it is possible to provide a color vision correction lens, etc. which have a less deeply tinted appearance.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a schematic cross-sectional view illustrating a color vision correction lens according to Embodiment 1.

FIG. 2 is a diagram illustrating an example of a transmission spectrum of a resin layer of the color vision correction lens according to Embodiment 1.

FIG. 3 is a diagram illustrating an example of a transmission spectrum of a reflective layer of the color vision correction lens according to Embodiment 1.

FIG. 4 is an enlarged sectional view illustrating the reflective layer of the color vision correction lens according to Embodiment 1.

FIG. 5 is a diagram illustrating an optical property of the color vision correction lens according to Embodiment 1.

FIG. 6 is a diagram illustrating intensities of lights on an outer side of the color vision correction lens according to Embodiment 1.

FIG. 7 is an enlarged sectional view illustrating a reflective layer of a color vision correction lens according to a variation of Embodiment 1.

FIG. 8 is a diagram illustrating an example of a transmission spectrum of the reflective layer of the color vision correction lens according to the variation of Embodiment 1.

FIG. 9 is a diagram illustrating intensities of lights on an outer side of the color vision correction lens according to the variation of Embodiment 1.

FIG. 10 is a perspective view illustrating a pair of eyeglasses which is an example of an optical component according to Embodiment 1.

FIG. 11 is a perspective view illustrating contact lenses which are an example of the optical component according to Embodiment 1.

FIG. 12 is a plan view illustrating an intraocular lens which is an example of the optical component according to Embodiment 1.

FIG. 13 is a perspective view illustrating a pair of goggles which is an example of the optical component according to Embodiment 1.

FIG. 14 is a perspective view illustrating a pair of eyeglasses to which a pair of clip-on eyeglasses is attached, and which is an example of an optical component according to Embodiment 2.

FIG. 15 is a cross-sectional view illustrating schematic cross sections and optical properties of a color vision correction lens according to Embodiment 2.

FIG. 16 is a diagram illustrating spectral reflectance of human skin.

FIG. 17 is a diagram illustrating color correction in a CIE 1931 chromaticity coordinate system.

FIG. 18 is a diagram illustrating a result obtained by simulating an optical property of a color vision correction lens.

### DETAILED DESCRIPTION

Hereinafter, a color vision correction lens and an optical component according to an embodiment of the present disclosure will be described in detail with reference to the drawings. Note that the embodiments described below each show a specific example of the present disclosure. Accordingly, the numerical values, shapes, materials, structural elements, the arrangement and connection of the structural elements, steps, an order of the steps, etc. described in the following embodiments are all mere examples, and thus are not intended to limit the present disclosure. Thus, structural elements not recited in any one of independent claims among structural elements in the following embodiments are described as optional structural elements.

Note that the drawings are schematic diagrams, and do not necessarily provide strictly accurate illustration. Thus, the scale, etc. of the drawings do not necessarily coincide with each other. Throughout the drawings, the same reference sign is given to substantially the same configuration, and redundant description is omitted or simplified.

In addition, each of a numerical value range, a term which indicates a relationship between structural elements, such as coincides with or equals to, and a term which indicates the shape of the structural elements, such as spherical or flat, is not an expression that only indicates the strict meaning of the expression, but includes the scope of the expression that is substantially the same. For example, each of the expressions includes a difference of about several percent. In addition, the word “approximately” means to include the range of plus or minus 10% of a numerical value or a numerical value range.

### Embodiment 1

### [Configuration]

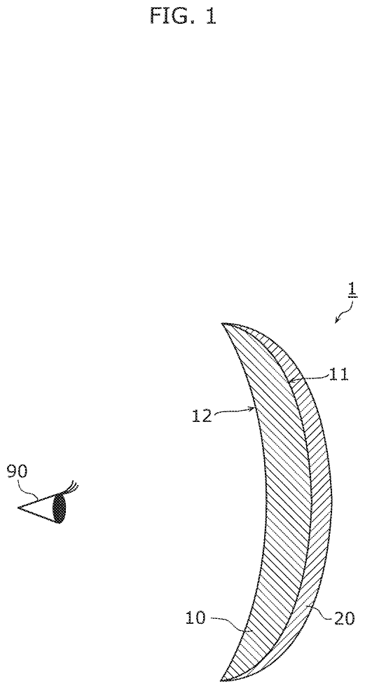

First, the configuration of a color vision correction lens according to Embodiment 1 will be described with reference to FIG. 1.

FIG. 1 is a schematic cross-sectional view illustrating color vision correction lens 1 according to Embodiment 1. As illustrated in FIG. 1, color vision correction lens 1 includes resin layer 10 and reflective layer 20.

Color vision correction lens 1 is a lens for correcting color vision deficiency which a person with color vision deficiency has. People with color vision deficiency are typically congenitally color-blind to red and green, and perceive green light more intensely than red light. Color vision correction lens 1 is capable of keeping a perceptional balance between red light and green light by reducing the transmission of green light, and thus color vision can be corrected.

Resin layer 10 is a plate-like, light-transmissive component. Specifically, resin layer 10 is formed by molding a transparent resin material into a predetermined shape. For example, resin layer 10 includes a resin material, such as acrylic resin, epoxy resin, urethane resin, polysilazane, siloxane, allyl diglycol carbonate (CR-39) or polysiloxane acrylic hybrid resin, polycarbonate, etc.

Resin layer 10 has the thickness of, for example, at least 1 mm and at most 3 mm. Resin layer 10 includes convex surface 11 and concave surface 12. Concave surface 12 is an example of a first surface of color vision correction lens 1 which faces an eye of user 90. Convex surface 11 is an example of a second surface which is on an opposite side of concave surface 12. That is, convex surface 11 is an outer principal surface which is on the opposite side of the eye of user 90.

Each of convex surface 11 and concave surface 12 has the radius of curvature of at least 60 mm and at most 800 mm. Each of convex surface 11 and concave surface 12 may have the radius of curvature of at least 100 mm and at most 300 mm. Convex surface 11 has the radius of curvature different from the radius of curvature of concave surface 12. For example, convex surface 11 has the radius of curvature smaller than the radius of curvature of concave surface 12. That is, the distance between convex surface 11 and concave surface 12, or in other words, the thickness of resin layer 10 is different depending on a portion of resin layer 10. Accordingly, resin layer 10 has both a thin portion and a thick portion.

Note that convex surface 11 and concave surface 12 may have the same radius of curvature. The distance between convex surface 11 and concave surface 12 may be constant regardless of a portion of resin layer 10. That is, resin layer 10 may have thickness that is uniform. The thickness of resin layer 10 may be less than 1 mm, or greater than 3 mm.

In addition, convex surface 11 and concave surface 12 each have, for example, a spherical surface, but need not have a complete spherical surface. For example, in a cross-sectional view of resin layer 10, the roundness of convex surface 11 and concave surface 12 may be at least several μm and at most ten-odd μm. Furthermore, one of convex surface 11 and concave surface 12 may be flat.

Resin layer 10 may have a function of condensing or diffusing light like a function performed by a convex lens or a concave lens. The size and the shape of resin layer 10 are, for example, the size and the shape suitable for a pair of eyeglasses, a contact lens, etc. wearable by a person.

Resin layer 10 contains a color material which selectively absorbs light in a first wavelength band. The color material is evenly dispersed in resin layer 10. Specifically, the color material is evenly dispersed inside of and throughout the entirety of resin layer 10 in the thickness direction and the surface direction of resin layer 10.

Note that the color material may be dispersed only in a portion of resin layer 10. For example, the color material may be dispersed only in the central portion of resin layer 10 when convex surface 11 of resin layer 10 is seen from the front face. Alternatively, the color material may be dispersed only in the outer layer part, including convex surface 11, in the thickness direction of resin layer 10.

The color material is a dye material which absorbs light in the first wavelength band. The first wavelength band is a wavelength band which includes the wavelength of an absorption peak of the color material. The first wavelength band is a range having the absorptance of at least a quarter of absorptance of the absorption peak in the absorption spectrum of the color material, for example. Note that the first wavelength band may be a range having the absorptance of at least a tenth of the absorptance of the absorption peak. The first wavelength band is in the range of at least 430 nm and at most 600 nm. The color material does not practically absorb any light other than light in the first wavelength band in the visible light band. For example, the color material has transmittance of at least 80% with respect to light other than light in the first wavelength band. The visible light band is in the range of, for example, at least 380 nm and at most 780 nm.

The color material includes at least one type of dye material. For example, resin layer 10 includes several types of dye materials which are mixed together and dispersed throughout resin layer 10. A porphyrin dye, a phthalocyanine dye, a merocyanine dye, or a methine dye can be used as a dye material, for example.

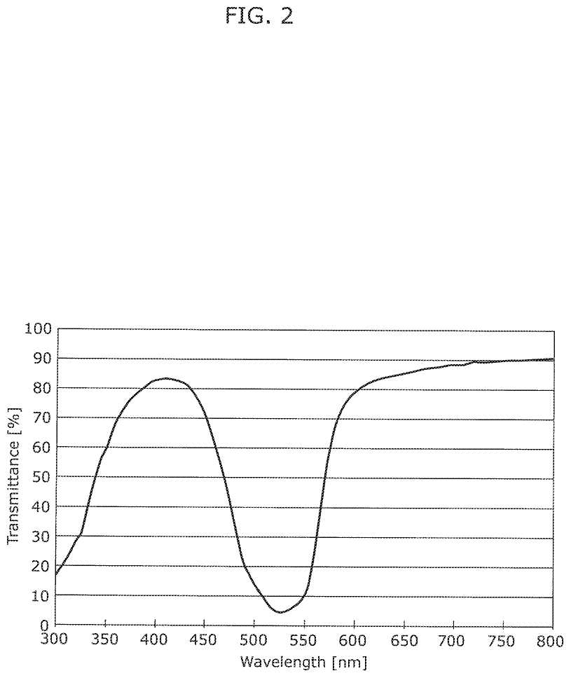

FIG. 2 is a diagram illustrating an example of a transmission spectrum of resin layer 10 of color vision correction lens 1 according to the embodiment. In FIG. 2, the horizontal axis represents a wavelength (unit: nm), and the vertical axis represents transmittance (unit: %).

The transmittance is at most 80% in a wavelength ranging from 430 nm to 600 nm in the transmission spectrum illustrated in FIG. 2. That is, the wavelength band ranging from 430 nm to 600 nm includes a transmittance dip. The transmittance dip corresponds to the absorption peak of the color material. The peak wavelength of the absorption peak, or in other words, the minimum value of the wavelength in the transmittance dip is approximately 525 nm. The transmittance has the minimum value of approximately 5% at the wavelength of approximately 525 nm. The absorptance of the absorption peak is approximately 95% without considering the reflection of light off the surface of resin layer 10. The full width at half maximum of the absorption peak is, for example, approximately 100 nm.

Note that the transmission spectrum (absorption spectrum) of resin layer 10 is not limited to the example illustrated in FIG. 2. The peak wavelength may be a value within the range of at least 430 nm and at most 600 nm, but different from 525 nm, and may also be a value within the range of at least 500 nm and at most 570 nm, but different from 525 nm, for example. In addition, the transmittance of the peak wavelength may be less than 10% or more than or equal to 10%. Resin layer 10 is to absorb the transmission of an appropriate wavelength in accordance with a person who is subjected to color vision correction (i.e., user 90 who uses color vision correction lens 1).

Reflective layer 20 is on the convex surface 11 side of resin layer 10. Specifically, reflective layer 20 is disposed on convex surface 11 as illustrated in FIG. 1. More specifically, reflective layer 20 is in contact with convex surface 11, and is provided so as to cover the entirety of convex surface 11. Resin layer 10 and reflective layer 20 are integrally formed. In other words, resin layer 10 and reflective layer 20 are adhered to each other in the embodiment, and resin layer 10 and reflective layer 20 are inseparable under normal usage.

Reflective layer 20 selectively reflects light in a second wavelength band. Specifically, reflective layer 20 reflects light in the second wavelength band, and allows light other than the light in the second wavelength band to pass through. The second wavelength band is a range having reflectance of at least a quarter of the reflectance of a reflection peak in the reflection spectrum of reflective layer 20, for example. Note that the second wavelength band may be a range having the reflectance of at least a tenth of the reflectance of the reflection peak. The second wavelength band is narrower than the first wavelength band in the embodiment, and is entirely included in the first wavelength band. For example, the second wavelength band is in the range of at least 500 nm and at most 570 nm. That is, reflective layer 20 reflects green light. The peak reflectance of reflective layer 20 is at least 10% and at most 99%.

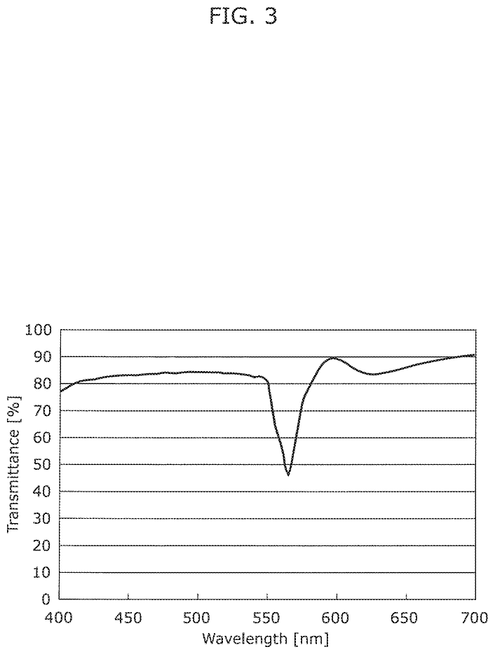

FIG. 3 is a diagram illustrating an example of the transmission spectrum of reflective layer 20 of color vision correction lens 1 according to the embodiment. In FIG. 3, the horizontal axis represents a wavelength (unit: n and the vertical axis represents transmittance (unit: %).

The transmittance is at most 80% in a wavelength ranging from 550 nm to 580 nm in the transmission spectrum illustrated in FIG. 3. That is, the wavelength band ranging from 550 nm to 580 nm includes a transmittance dip. The transmittance dip corresponds to a reflectance peak of reflective layer 20. The peak wavelength of the reflectance peak, or in other words, the wavelength having the minimum value in the transmittance dip is approximately 565 nm. The transmittance has the minimum value of approximately 46% at the wavelength of approximately 565 nm. The reflectance (peak reflectance) of the reflection peak is approximately 54% without considering the absorption by reflective layer 20. The full width at half maximum of the reflection peak is, for example, approximately 25 nm.

As such, in the embodiment, the reflection peak of reflective layer 20 is included in a wavelength band (first wavelength band) of the absorption peak of resin layer 10. The full width at half maximum of the reflection peak is narrower than the full width at half maximum of the absorption peak. That is, reflective layer 20 has the reflection peak that is steeper than the absorption peak of resin layer 10. The steep reflection peak is formed due to a colloidal crystal structure. Accordingly, reflective layer 20 includes the colloidal crystal structure in the embodiment. Reflective layer 20 reflects a portion of incident light using Bragg reflection exhibited by the colloidal crystal structure, and allows the remaining portion of the incident light to pass through.

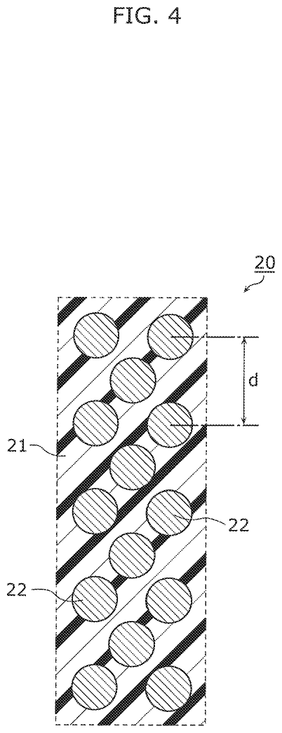

FIG. 4 is an enlarged sectional view illustrating reflective layer 20 of color vision correction lens 1 according to the embodiment. As illustrated in FIG. 4, reflective layer 20 includes matrix material 21 and a plurality of colloidal particles 22.

Matrix material 21 is provided so as to fill spaces between the plurality of colloidal particles 22. Matrix material 21 includes an organic material. The organic material which matrix material 21 includes is a resin material having a high light transmittance in the visible light band. Specifically, as the resin material, at least one material selected from a group consisting of acrylic resin, polycarbonate resin, cycloolefin resin, epoxy resin, silicone resin, an acrylic styrene copolymer, styrene resin, and urethane resin can be used.

The plurality of colloidal particles 22 each have the size of a colloidal dimension. All of the plurality of colloidal particles 22 have the same size and the same shape. The colloidal dimension is equivalent to a nano-order size. Specifically, colloidal particle 22 is a spherical particle having a diameter of at least 1 nm and less than 1000 nm. For example, colloidal particle 22 may have the diameter of at least 150 nm and at most 300 nm.

Colloidal particle 22 includes at least one of an inorganic material and a resin material. That is, colloidal particle 22 may only include the inorganic material or the resin material. Alternatively, colloidal particle 22 may include both the inorganic material and the resin material.

The inorganic material may be, for example, a metal, such as gold or silver, or a metallic oxide, such as silica, alumina, or titania. In addition, the resin material may be styrene resin or acrylic resin. Colloidal particle 22 may include, among the aforementioned materials, one type of material or several types of materials combined.

The colloidal crystal structure includes the plurality of colloidal particles 22 which are regularly and three-dimensionally arranged. The mean value of center-to-center distance d between colloidal particles 22 is, for example, at least 100 nm and at most 500 nm. The mean value of center-to-center distance d may be at least 200 nm and at most 350 nm, or may be at least 220 nm and at most 300 nm. An adjustment to the mean value of center-to-center distance d makes it possible to realize reflective layer 20 which reflects light having a desired wavelength component. Specifically, it is possible to realize reflective layer 20 having a steep reflection peak and the full width at half maximum that is narrow. Note that center-to-center distance d can be checked by examining the surface of the colloidal crystal structure with a scanning electron microscope.

In addition, the ratio of the total volume of all colloidal particles 22 to the volume of reflective layer 20 is, for example, at least 10 vol % and at most 60 vol %. Alternatively, the ratio may be at least 20 vol % and at most 50 vol %, and may be at least 25 vol % and at most 40 vol %, By limiting the ratios within the ranges as described above, the colloidal crystal structure is capable of having suitable light transmittance and suitable shape stability. Adjacent colloidal particles 22 may be in contact with each other.

The thickness of reflective layer 20 is less than that of resin layer 10. For example, the thickness of reflective layer 20 is at least 10 μm and less than 3000 μm (3 mm), The thickness of reflective layer 20 may be at least 1 mm. For example, the thickness of reflective layer 20 may be at least 30 μm and at most 50 μm.

Note that so long as reflective layer 20 is capable of reflecting light in the second wavelength band, the shape, the size, and the regularity of the plurality of colloidal particles 22 need not be precise. That is, the plurality of colloidal particles 22 may include colloidal particles not in the shape of a sphere and in different sizes. In addition, the plurality of colloidal particles 22 may be irregularly arranged.

Reflective layer 20 is formed by hardening dispersion liquid applied on convex surface 11 of resin layer 10. The dispersion liquid is obtained by dispersing the plurality of colloidal particles 22 in a raw material, such as aforementioned acrylic resin, which is included in matrix material 21. Note that the method of forming reflective layer 20 is not particularly limited.

For example, a spray coating method, a spin coating method, a slit coating method, a roll coating method, etc. can be used as a method to apply the dispersion liquid. In addition, the method of polymerizing monomers is not limited. The monomers may be polymerized by heating, and by using an active energy ray (an electromagnetic wave, an ultraviolet ray, visible light, infrared light, an electron beam, a gamma ray, etc.). When the monomers are polymerized using an active energy ray, a photopolymerization initiator, etc. may be added to the dispersion liquid. A well-known photopolymerization initiator, such as a radical photopolymerization initiator, a cationic photopolymerization initiator, and an anionic photopolymerization initiator, etc., can be used as the photopolymerization initiator.

### [Optical Property of Color Vision Correction Lens]

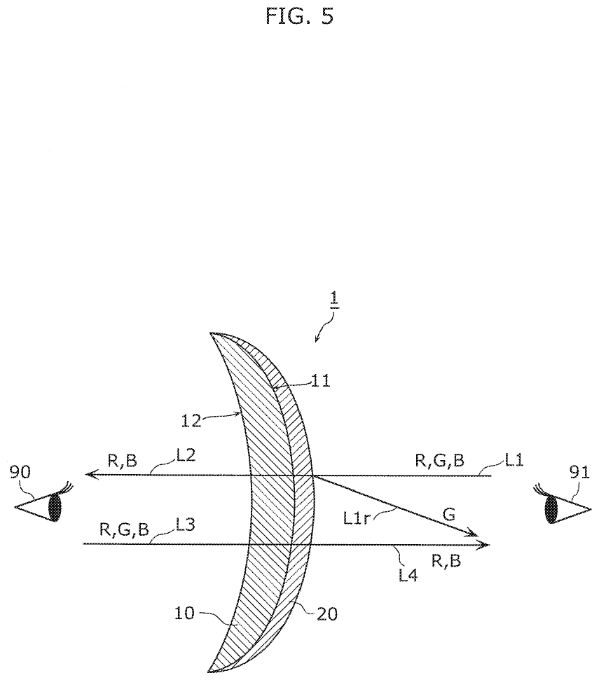

FIG. 5 is a diagram illustrating an optical property of color vision correction lens 1 according to the embodiment. FIG. 5 schematically illustrates an eye of user 90 who is a wearer of a pair of eyeglasses, and an eye of other person 91 who is different from user 90 in the case in which color vision correction lenses 1 are used for the pair of eyeglasses. User 90 is a person with color vision deficiency. As illustrated in FIG. 5, color vision correction lens 1 includes resin layer 10 on the user 90 side, and reflective layer 20 on the other person 91 side.

An eye of user 90 who is a person with color vision deficiency receives light L2 which has passed through color vision correction lens 1 in the order of reflective layer 20 and resin layer 10. Light L2 is a portion of light L1 which enters color vision correction lens 1 from the reflective layer 20 side and passes through color vision correction lens 1. Another portion of light L1 is reflected as reflected light L1r when light L1 passes through reflective layer 20.

In this embodiment, reflective layer 20 reflects green light, and resin layer 10 absorbs green light. For this reason, light L2 mainly includes, among a red component (R), a green component (G), and a blue component (B) included in light L1, the red component and the blue component since the green component is either reflected or absorbed. This removal of the green component enables user 90 who is a person with color vision deficiency to keep the perceptional balance between red and green, and thus color vision can be corrected. That is, the function of correcting color vision which color vision correction lens 1 performs can be sufficiently demonstrated.

On the other hand, when other person 91 looks at the face of user 90, an eye of other person 91 receives light L4, which has passed through color vision correction lens 1 in the order of resin layer 10 and reflective layer 20, and reflected light L1r, which is a portion of light L1. Light L4 is a portion of light L3 which enters color vision correction lens 1 and passes through color vision correction lens 1 from the resin layer 10 side.

Since resin layer 10 absorbs the green component included in light L3, light L4 mainly includes the red component and the blue component. An eye of other person 91 receives mixed light which includes the red component, the green component, and the blue component since reflected light L1r which is green light is added to light L4 in the embodiment.

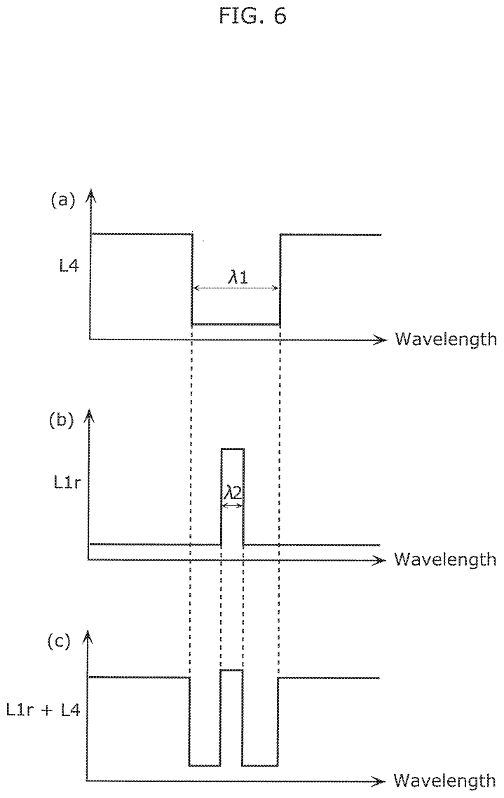

FIG. 6 is a diagram illustrating intensities of lights on an outer side of color vision correction lens 1 according to the embodiment. Specifically, (a), (b), and (c) of FIG. 6 illustrate the intensity of light L4, reflected light L1r, and the mixed light in which light L4 and reflected light L1r are mixed, respectively. Each of (a), (b), and (c) of FIG. 6 includes the horizontal axis representing a wavelength and the vertical axis representing the intensity of light.

Note that (a) of FIG. 6 corresponds to the wavelength dependency of transmittance of resin layer 10. Part (b) of FIG. 6 corresponds to the wavelength dependency of transmittance of reflective layer 20. That is, a portion where the intensity of light L4 is low corresponds to first wavelength band λ1, and a portion in the wavelength of reflected light L1r corresponds to second wavelength band λ2.

When reflective layer 20 is not provided, light L4 illustrated in (a) of FIG. 6 enters an eye of other person 91 since reflected light L1r does not enter the eye of other person 91. The lack of the green component causes color vision correction lens 1 to have a tinted appearance. On the contrary, as illustrated in (c) of FIG. 6, since the mixed light includes the green component of reflected light L1r illustrated in (b) of FIG. 6 in the embodiment, color vision correction lens 1 has a less deeply tinted appearance.

Note that as illustrated in (b) and (c) of FIG. 6, second wavelength band λ2 of light reflected by reflective layer 20 may be narrower than first wavelength band λ1 of light absorbed by resin layer 10. This way, color vision correction lens 1 has a less deeply tinted appearance compared to the case where there is no reflected light L1r.

### [Variation]

Next, color vision correction lens 1 according to a variation will be described. In comparison with Embodiment 1, reflective layer 20 has a different configuration in the variation described below. The following mainly describes a difference between the variation and Embodiment 1, and the description of the common features will be omitted or simplified.

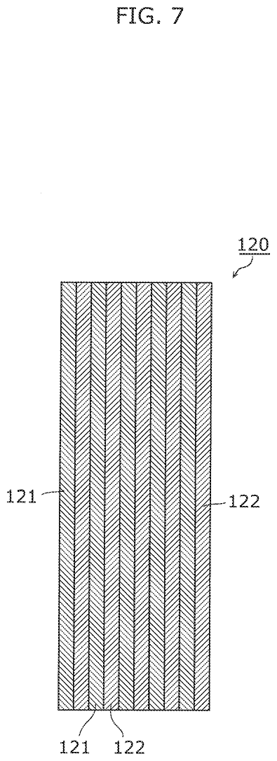

FIG. 7 is an enlarged sectional view illustrating reflective layer 120 of a color vision correction lens according to the variation. As illustrated in FIG. 7, reflective layer 120 includes a multilayer reflective film in which a plurality of dielectric films 121 and a plurality of dielectric films 122 are disposed. Reflective layer 120 is formed by alternately disposing, one by one, the plurality of dielectric films 121 and the plurality of dielectric films 122, for example.

Dielectric film 121 and dielectric film 122 each include a light-transmissive material having a refractive index different from each other. For example, dielectric film 121 and dielectric film 122 each include a titanium oxide film, a hafnium oxide film, a silicon oxide film, etc. Adjustments to the thickness and the refractive index of each film and the selection of a material for each film allow light having a targeted wavelength to be reflected and light having a wavelength other than the targeted wavelength to pass through.

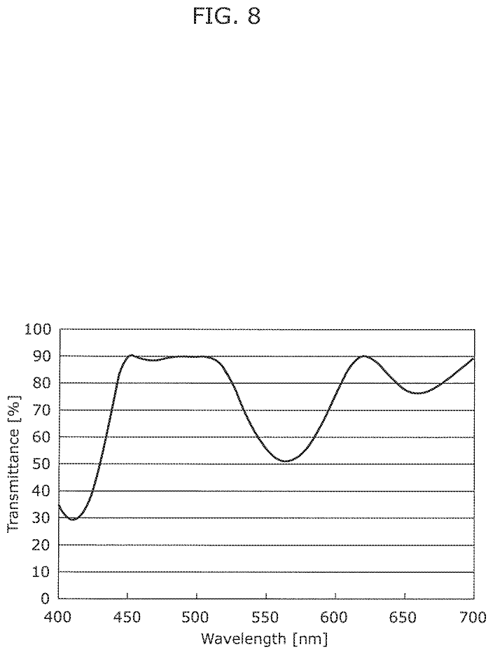

FIG. 8 is a diagram illustrating an example of a transmission spectrum of reflective layer 120 of the color vision correction lens according to the variation. In FIG. 8, the horizontal axis represents a wavelength (unit: nm), and the vertical axis represents transmittance (unit: %).

The transmittance is at most 80% in a wavelength ranging from 525 nm to 604 nm in the transmission spectrum illustrated in FIG. 8. That is, the wavelength band ranging from 525 nm to 604 nm includes a transmittance dip. The transmittance dip corresponds to the reflectance peak of reflective layer 120. The minimum value of the wavelength in the transmittance dip, or in other words, the peak wavelength of the reflectance peak, is approximately 565 nm. The transmittance has the minimum value of approximately 52% at the wavelength of approximately 565 nm. The reflectance (peak reflectance) of the reflection peak is approximately 48% without considering the absorption of light by reflective layer 20. The full width at half maximum of the reflection peak is approximately 55 nm.

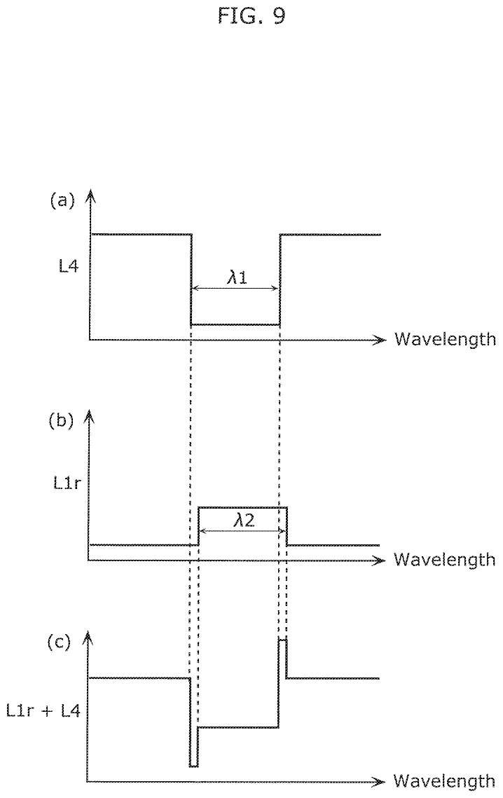

As such, reflective layer 120 which includes the multilayer reflective film has the reflection peak that is less steep than the reflection peak of reflective layer 20 which includes the colloidal crystal structure. In this case, a portion of second wavelength band λ2 of light which reflective layer 120 reflects need not be included in first wavelength band λ1 of light which resin layer 10 absorbs as illustrated in FIG. 9.

FIG. 9 is a diagram illustrating intensities of lights on an outer side of color vision correction lens 1 according to the variation. Specifically, (a), (b), and (c) of FIG. 9 illustrate the intensity of light L4, reflected light L1r, and the mixed light in which light L4 and reflected light L1r are mixed, respectively. Each of (a), (b), and (c) of FIG. 9 include the horizontal axis representing a wavelength and the vertical axis representing the intensity of light.

Note that (a) of FIG. 9 corresponds to the wavelength dependency of transmittance of resin layer 10. Part (b) of FIG. 9 corresponds to the wavelength dependency of the transmittance of reflective layer 120. That is, the range in which the intensity of light L4 is low corresponds to first wavelength band λ1, and a portion in the wavelength of reflected light L1r corresponds to second wavelength band λ2.

As illustrated in (c) of FIG. 9, when a portion of second wavelength band λ2 of reflected light L1r is not included in first wavelength band λ1, the mixed light partially includes a wavelength component. Even in this case, color vision correction lens 1 has a less deeply tinted appearance since at least a portion of first wavelength band λ1 which is to be absorbed is supplemented by reflected light L1r.

### [Optical Component]

Color vision correction lens 1 described above is used for various optical components.

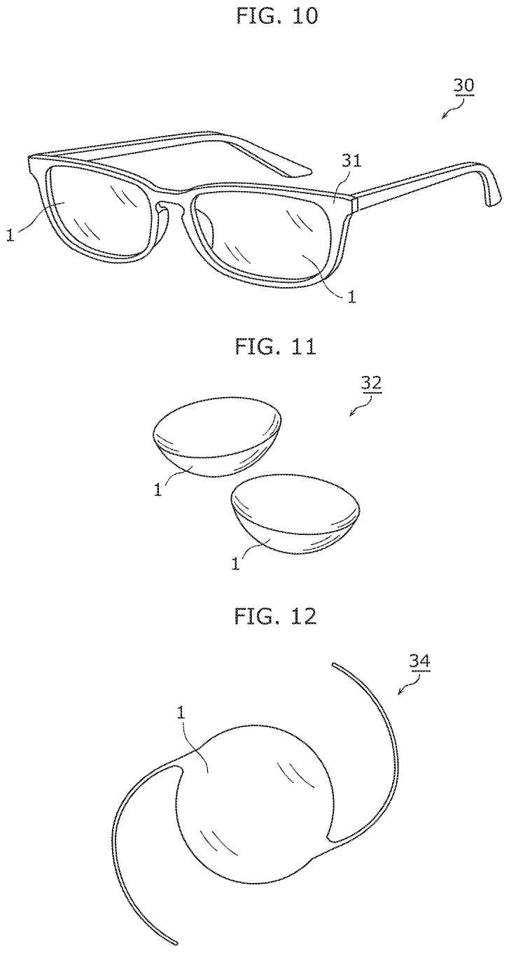

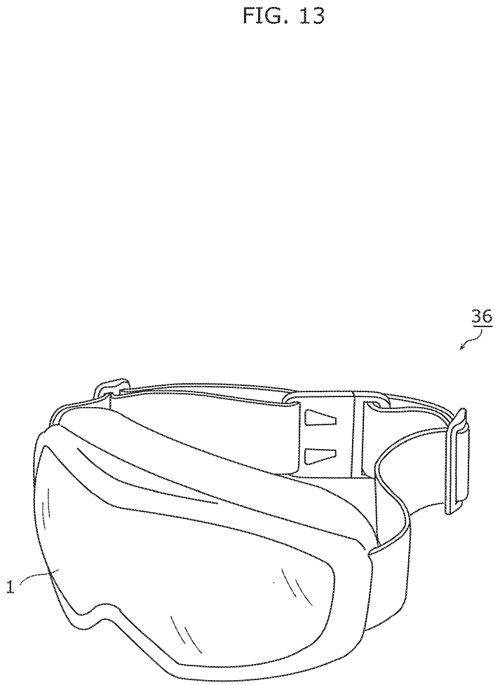

FIG. 10 through FIG. 13 are diagrams each illustrating an example of an optical component that includes color vision correction lens 1 according to the embodiment, Specifically, FIG. 10, FIG. 11, and FIG. 13 each are a perspective view of an example of an optical component illustrating pair of eyeglasses 30, contact lenses 32, and pair of goggles 36, respectively. FIG. 12 is a plan view of intraocular lens 34 which is an example of an optical component. For example, pair of eyeglasses 30, contact lenses 32, intraocular lens 34, and pair of goggles 36 each include color vision correction lens 1 as illustrated in each of the drawings.

For example, pair of eyeglasses 30 includes two color vision correction lenses 1 as right and left lenses, and frame 31 which supports the two color vision correction lenses 1. Each of contact lenses 32 and intraocular lens 34 are color vision correction lens 1 as a whole. Alternatively, only the center portion of contact lenses 32 and intraocular lens 34 may be color vision correction lens 1. Pair of goggles 36 includes one color vision correction lens 1 as a cover lens for covering both eyes.

Note that pair of eyeglasses 30, contact lenses 32, intraocular lens 34, and pair of goggles 36 each may include a color vision correction lens which includes reflective layer 120 described above in the variation.

### [Advantageous Effects, Etc.]

As has been described above, color vision correction lens 1 according to the embodiment corrects the color vision of user 90. Color vision correction lens 1 includes resin layer 10 that includes concave surface 12 which is an example of a first surface facing an eye of user 90 and convex surface 11 which is an example of a second surface on the opposite side of concave surface 12, and reflective layer 20 or 120 which is disposed on the convex surface 11 side. Resin layer 10 contains a color material which selectively absorbs light in the first wavelength band. Reflective layer 20 or 120 selectively reflects light in the second wavelength band. The first wavelength band and the second wavelength band overlap at least partially.

Accordingly, when other person 91 who is different from user 90 looks at color vision correction lens 1, an eye of other person 91 receives mixed light in which reflected light L1r reflected by reflective layer 20 and light L4 that passes through color vision correction lens 1 are mixed. Although a component of the first wavelength band is reduced from light L4 due to absorption by resin layer 10, at least a portion of the reduction is supplemented by reflected light L1r in the second wavelength band. Thus, it is possible to provide color vision correction lens 1 which has a less deeply tinted appearance. In addition, reflective layer 20 or 120 may be disposed on convex surface 11, for example. With this, it is possible to realize color vision correction lens 1 that is smaller and lighter since resin layer 10 and reflective layer 20 can be adhere to each other.

Note that when user 90 uses color vision correction lens 1, an eye of user 90 receives light L2 from which first wavelength band component is reduced due to resin layer 10. For this reason, it is possible to sufficiently demonstrate an essential function (color vision correction function) of color vision correction lens 1.

In addition, the second wavelength band is in the range of at least 500 nm and at most 570 nm, for example.

With this, color vision correction lens 1, which corrects the color vision of a person who is congenitally color-blind to red and green, can have a less deeply tinted appearance since the transmission of green light is reduced.

In addition, reflective layer 20 or 120 has the peak reflectance of at least 10% and at most 99%.

With the adjustment of the peak reflectance as above, it is possible to reduce the glittering (glaring) of color vision correction lens 1.

In addition, the second wavelength band is narrower than the first wavelength band, and is entirely included in the first wavelength band, for example.

Accordingly, the amount of light of reflected light L1r can be reduced by making the second wavelength band narrower even when the peak reflectance is high. Therefore, it is possible to reduce the glittering of color vision correction lens 1.

In addition, reflective layer 20 includes the colloidal crystal structure, for example.

With this, the reflection spectrum of the colloidal crystal structure is less dependent on angles. Thus, color vision correction lens 1 can have a less deeply tinted appearance not only when color vision correction lens 1 is seen from the front face, but also from an oblique direction. In addition, the colloidal crystal structure can readily form a steep reflection peak. That is, the peak reflectance of reflective layer 20 can be increased, and the full width at half maximum of the reflection peak can be made narrower. This can suppress the intense reflection by reflective layer 20, or in other words, the amount of light of reflected light L1r. Therefore, color vision correction lens 1 can have a less glittering appearance.

As has been described above, the optical components according to the embodiment each include color vision correction lens 1. The optical components are, for example, pair of eyeglasses 30, contact lenses 32, intraocular lens 34, or pair of goggles 36.

With this, an optical component wearable by user 90, such as pair of eyeglasses 30, can be realized. If user 90 happens to wear pair of eyeglasses 30 which does not have a less deeply tinted appearance, other person 91 may find the appearance of pair of eyeglasses 30 somewhat odd. Since pair of eyeglasses 30 has a less deeply tinted appearance according to the embodiment, it is possible to reduce the sense of oddness felt by other person 91 in daily life.

### Embodiment 2

Next, Embodiment 2 will be described.

In Embodiment 2, a resin layer and a reflective layer are separable. In other words, the reflective layer is capable of changing the positional relationship relative to the resin layer. The following mainly describes a difference between Embodiment 2 and Embodiment 1, and the description of the common features will be omitted or simplified.

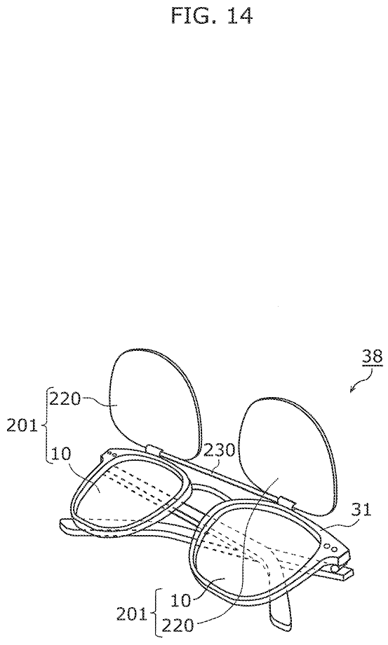

FIG. 14 is a perspective view illustrating pair of eyeglasses 38 to which a pair of clip-on eyeglasses is attached. Pair of eyeglasses is an example of an optical component according to the embodiment. As illustrated in FIG. 14, pair of eyeglasses 38 includes frame 31 and two color vision correction lenses 201.

The two color vision correction lenses 201 have the same configuration. Note that the two color vision correction lenses 201 are for a left eye and a right eye, and thus the shape of color vision correction lens 201 for the left eye is different from the shape of color vision correction lens 201 for the right eye.

As illustrated in FIG. 14, color vision correction lens 201 includes resin layer 10 and reflective layer 220. Resin layer 10 is the same as resin layer 10 of color vision correction lens 1 according to Embodiment 1. That is, resin layer 10 contains a color material which selectively absorbs light in a first wavelength band. Resin layer 10 mainly absorbs the green component of light to reduce the transmission of the green component. In this embodiment, reflective layer 20 is not provided on convex surface 11 of resin layer 10.

In a plan view of convex surface 11 of resin layer 10, reflective layer 220 is movable to a position at which reflective layer 220 covers convex surface 11 and a position at which reflective layer 220 does not cover convex surface 11. For example, reflective layer 220 is rotatably attached to frame 31 of pair of eyeglasses 38. Specifically, as illustrated in FIG. 14, the two reflective layers 220 each are fixed to an end of shaft 230 which is rotatably supported by frame 31. With this, it is possible for reflective layer 220 to overlap resin layer by bringing reflective layer 220 closer to resin layer 10. Conversely, by bringing reflective layer 220 in a direction away from resin layer 10, it is possible for reflective layer 220 not to overlap resin layer 10 as illustrated in FIG. 1.4.

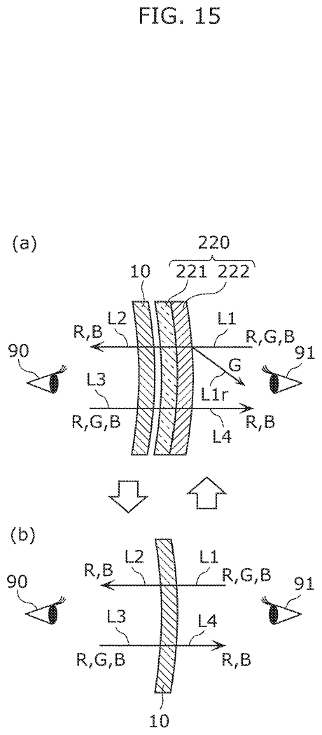

FIG. 15 is a cross-sectional view illustrating schematic cross sections and optical properties of color vision correction lens 201 according to the embodiment. Part (a) of FIG. 15 illustrates the case in which convex surface 11 of resin layer 10 is covered with reflective layer 220. Part (b) of FIG. 15 illustrates the case in which convex surface 11 of resin layer 10 is not covered with reflective layer 220 (i.e., the case illustrated in FIG. 14).

As illustrated in (a) of FIG. 15, reflective layer 220 includes transparent base material 221 and reflective film 222. Transparent base material 221 is a light-transmissive component which supports reflective film 222. Transparent base material 221 includes, for example, a light-transmissive resin material which is the same as the resin material included in resin layer 10. Transparent base material 221 does not include a dye material. That is, transparent base material 221 has transmittance that is high enough with respect to visible light. Transparent base material 221 may be a transparent glass plate.

Reflective film 222 is the same as reflective layer 20 according to Embodiment 1. Reflective film 222 is disposed on transparent base material 221. Reflective film 222 may be the same as reflective layer 120 according to the variation of Embodiment 1.

When reflective layer 220 and resin layer 10 overlap each other as illustrated in (a) of FIG. 15, pair of eyeglasses 38 according to the embodiment allows mixed light in which light L4 and reflected light L1r reflected by reflective layer 220 are mixed to enter an eye of other person 91 in the same manner as described in Embodiment 1. Since the mixed light includes the green component of reflected light L1r, color vision correction lens 201 has a less deeply tinted appearance.

Note that since a portion of light L1 is reflected as reflected light L1r when light L1 enters reflective layer 220, the intensity of light received by user 90 decreases. On the contrary, since no light is attenuated by reflective layer 220 when reflective layer 220 and resin layer 10 do not overlap each other as illustrated in (b) of FIG. 15, it is possible to increase the amount of light received by user 90. Accordingly, it is possible to ensure the visibility of user 90 even in a place with small amount of light. This is practical when it is not necessary for user 90 to worry about how other person 91 sees user 90, such as when user 90 is alone.

As has been described above, color vision correction lens 201 according to the embodiment includes reflective layer 220 that is movable to a position at which reflective layer 220 covers convex surface 11 and a position at which reflective layer 220 does not cover convex surface 11 in a plan view of convex surface 11 of resin layer 10.

With this, it is possible to switch between improvement in the appearance of user 90 and the assurance of the visibility of user 90 according to circumstances.

Note that resin layer 10 and reflective layer 220 may be completely separated. That is, color vision correction lens 201 may include resin layer 10 and reflective layer 220 which are attachable to and detachable from each other. For example, shaft 230 which supports two reflective layers 220 may be provided with a clip member. Reflective layer 220 can overlap resin layer 10 by fastening the clip member to frame 31 of pair of eyeglasses 38. By removing the clip member from frame 31, reflective layer 220 does not overlap resin layer 10. The way of attaching reflective layer 220 to resin layer 10 and the way of detaching reflective layer 220 from resin layer 10 are not particularly limited. In addition, although (a) of FIG. 15 illustrates the example in which resin layer 10 and reflective layer 220 are spaced apart, resin layer 10 and reflective layer 220 may be adhered to each other.

### (Others)

The following describes the concept of designing an optical characteristic and a result obtained by simulating the optical characteristic of the color vision correction lenses according to the embodiments described above.

As has been described above, the present disclosure aims to provide color vision correction lens 1 or 201 according the embodiments which has a less deeply tinted appearance. Specifically, the present disclosure aims to reduce the sense of oddness felt by other person 91 when other person 91 sees user 90 who has color vision deficiency and is using color vision correction lens 1 or 201.

For example, when color vision correction lenses 1 or 201 are used for pair of eyeglasses 30 or 38, other person 91 will look at the eyes and the skin around the eyes of user 90 via color vision correction lenses 1 or 201. For this reason, the oddness felt by other person 91 can be reduced if the human skin color seen via color vision correction lenses 1 or 201 is closer to the original human skin color. Note that the original human skin color is the color seen not via color vision correction lens 1 or 201. Accordingly, the optical characteristic of color vision correction lens 1 or 201 is designed such that the human skin color is closer to the original human skin color when the human skin color and color vision correction lens 1 or 201 overlap each other. Specifically, a condition that is appropriate for the reflection spectrum of reflective layer 20, 120, or 220 of color vision correction lens 1 or 201 is determined, and the reflection spectrum of reflective layer 20, 120, or 220 is adjusted so as to satisfy the condition determined.

The condition that is appropriate means that the peak wavelength of the second wavelength band of reflective layer 20, 120, or 220 is in the range in which CIE 1931 chromaticity coordinates are shifted toward white. The CIE 1931 chromaticity coordinates are obtained from a reflection spectrum which is obtained by multiplying the spectral reflectance of human skin and the spectral absorptance of color vision correction lens 1 or 201. Note that the CIE 1931 chromaticity coordinates are coordinates in the CIE 1931 color space defined by the Commission Internationale de l'Eclairage (CIE).

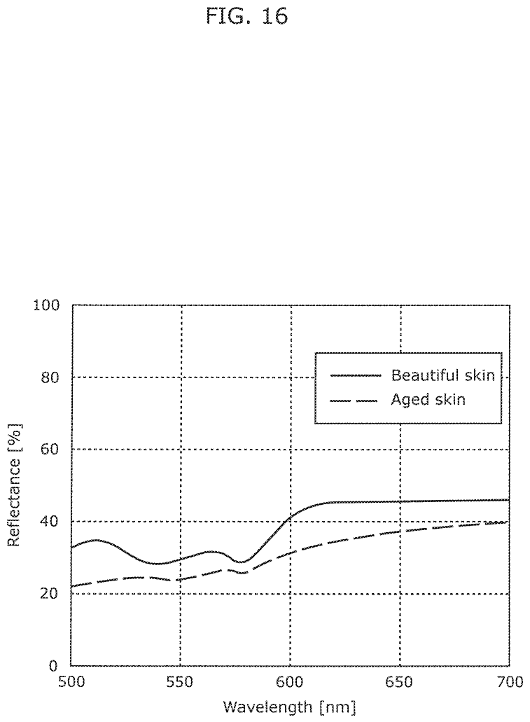

FIG. 16 is a diagram illustrating spectral reflectance of human skin. In FIG. 16, the horizontal axis represents a wavelength (unit: nm), and the vertical axis represents reflectance (unit: %). As illustrated in FIG. 16, although the spectral reflectance of human skin varies according to skin condition, it is more likely that the spectral reflectance is greater toward the long wavelength region. Note that since the human skin color varies with race, age, etc., the optical characteristic of color vision correction lens 1 or 201 may be developed for every race and age, or every combination of races and ages.

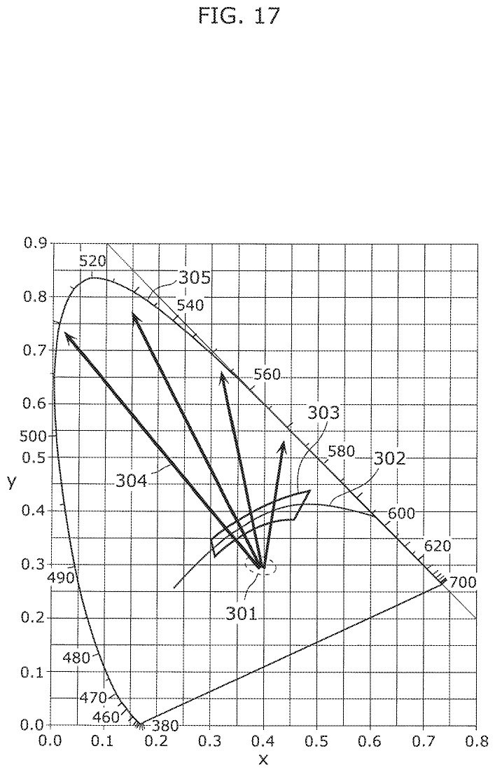

In designing color vision correction lens 1 or 201, the CIE 1931 chromaticity coordinates are calculated by multiplying, for example, the reflection spectrum of either “beautiful skin” or “aged skin” illustrated in FIG. 16 and the transmission spectrum of resin layer 10 illustrated in FIG. 2. The transmission spectrum of resin layer 10 corresponds to the absorption spectrum of a color material which selectively absorbs light in the first wavelength band. As illustrated in FIG. 17, the CIE 1931 chromaticity coordinates which have been calculated are included in area 301 in the CIE 1931 color space. Note that the location of area 301 is dependent on the spectral reflectance of skin and the absorption spectrum of the color material.

FIG. 17 is a diagram illustrating color correction in a CIE 1931 chromaticity coordinate system. FIG. 17 includes black body locus 302 and white region 303. White region 303 corresponds to a range which includes eight nominal correlated color temperatures (CCTs) illustrated in Table 1.

TABLE 1

| | | Allowable color |
|---|---|---|
| Nominal | Allowable | deviation (Duv) |
| CCT | CCT range | range |
| 2700 K | 2725 ± 145 K | 0.000 ± 0.006 |
| 3000 K | 3045 ± 175 K | 0.000 ± 0.006 |
| 3500 K | 3465 ± 245 K | 0.000 ± 0.006 |
| 4000 K | 3985 ± 275 K | 0.001 ± 0.006 |
| 4500 K | 4503 ± 243 K | 0.001 ± 0.006 |
| 5000 K | 5028 ± 283 K | 0.002 ± 0.006 |
| 5700 K | 5665 ± 355 K | 0.002 ± 0.006 |
| 6500 K | 6530 ± 510 K | 0.003 ± 0.006 |

A plurality of arrows 304 in FIG. 17 indicate directions toward which the CIE 1931 chromaticity coordinates which have been calculated are to be shifted by reflective layer 20, 120, or 220. The plurality of arrows 304 extend toward white region 303 from the CIE 1931 chromaticity coordinates which have been calculated as starting points. A wavelength at which spectral locus (monochromatic locus) 305 of the CIE 1931 color space and a direction to which arrow 304 is extending meet corresponds to the peak wavelength of the reflection peak. Note that since reflectance decreases as the length of arrow 304 shortens, color vision correction lens 1 or 201 can have a less glittering (glaring) appearance.

For example, suppose the CIE 1931 chromaticity coordinates which are obtained by multiplying the spectral reflectance of human skin and the transmission spectrum of resin layer 10 are to be (x1, y1). And suppose the CIE 1931 chromaticity coordinates of the peak wavelength of the reflection peak of reflective layer 20, 120, or 220 are to be (x2, y2). In this case, a line segment (straight line) connecting (x1, y1) and (x2, y2) passes through white region 303. As such, the peak wavelength of the reflection peak of reflective layer 20, 120, or 220 is determined so as to obtain a line segment which passes through white region 303. That is, the shifting of CIE 1931 chromaticity coordinates, which is obtained from a reflection spectrum obtained by multiplying the spectral reflectance of human skin and the spectral absorptance of resin layer 10, to white is to shift the CIE 1931 chromaticity coordinates (x1, y1) toward white region 303.

The following describes results obtained from simulations performed on color vision correction lens 1 or 201.

The color of the appearance of color vision correction lens 1 or 201 is calculated in the simulations in which a color of human skin and the transmission spectrum (the absorption spectrum of a color material) of resin layer 10 are fixed values, and the peak wavelength and the reflectance of reflective layer 20, 120, or 220 are variables. Note that the color of the appearance is the color of color vision correction lens 1 or 201 when color vision correction lens 1 or 201 is seen from the reflective layer side.

Table 2 below indicates results obtained from the simulations. In Table 2, Wavelength (unit: nm) indicates peak wavelengths of reflective layer 20, 120, or 220. Reflectance (unit: %) indicates reflectance of the peak wavelengths of reflective layer 20, 120, or 220. Note that the full width at half maximum of the reflection peak is 20 nm. The letters x and y denote CIE 1931 chromaticity coordinates of colors of the appearance of color vision correction lens 1 or 201. Values indicated for Wavelength and Reflectance are input values, and values indicated for the letters x and y are output values. That is, CIE 1931 chromaticity coordinates (x, y) are calculated for each of combinations of a value of a wavelength and a value of reflectance. A value of a wavelength and a value of reflectance, which are the input values, determine the amount of change (specifically, the direction and the length of arrow 304 illustrated in FIG. 17) in a color in the CIE 1931 color space. CIE 1931 chromaticity coordinates (x, y), which are the output values, are calculated by correcting coordinates (CIE 1931 chromaticity coordinates (x1, y1)) obtained by multiplying the spectral reflectance of human skin and the transmission spectrum of resin layer 10, based on the amount of change determined.

TABLE 2

| | Comparative | | | | | | | |
|---|---|---|---|---|---|---|---|---|
| | example | Ex. 1 | Ex. 2 | Ex. 3 | Ex. 4 | Ex. 5 | Ex. 6 | Ex. 7 |
| Wavelength | — | 550 | 550 | 550 | 570 | 530 | 510 | 510 |
| [nm] | | | | | | | | |
| Reflectance | — | 20 | 30 | 40 | 20 | 20 | 20 | 60 |
| [%] | | | | | | | | |
| x | 0.401 | 0.393 | 0.389 | 0.385 | 0.405 | 0.385 | 0.384 | 0.348 |
| y | 0.279 | 0.314 | 0.333 | 0.350 | 0.305 | 0.313 | 0.300 | 0.344 |

Comparative example indicated in Table 2 is the case in which reflective layer 20, 120, or 220 is not provided. In this case, the result which is obtained by multiplying the reflection spectrum of human skin and the transmission spectrum (the absorption spectrum of a color material) of resin layer 10 is simply obtained. The CIE 1931 chromaticity coordinates (x, y) are (0.401, 0.279), respectively, and the color pink, that is the color of resin layer 10, is most noticeable. Note that the CIE 1931 chromaticity coordinates (x, y) according to Comparative example are the CIE 1931 chromaticity coordinates (x1, y1) obtained by multiplying the spectral reflectance of human skin and the transmission spectrum of resin layer 10.

CIE 1931 chromaticity coordinates (x, y) of each of Examples 1 through 7 are closer to a skin color compared to Comparative example. That is, the color of an appearance becomes closer to the skin color by providing a reflective layer, and thus color vision correction lens 1 or 201 can have a natural appearance with reduced sense of oddness. Among Examples 1 through 7, Example 7 has obtained a color closest to the skin color.

In addition, among Examples 1 and 4 through 6 having the same reflectance of 20% and different peak wavelengths, Example 4 has obtained a color that is closest to the color of Comparative example, and Example 1 has obtained a color that is closest to the skin color. From the above, it can be understood that the obtaining of a color that is closer to the skin color is more effective when the peak wavelength is closer to the short wavelength region.

Furthermore, among Examples 1 through 3 having the same peak wavelength of 550 nm and different reflectance, Example 1 has obtained a color that is closest to the color of Comparative example, and Example 3 has obtained a color that is closest to the skin color. From the above, it can be understood that the obtaining of a color that is closer to the skin color is more effective when the reflectance is higher. Similarly, Example 7 having a high reflectance has obtained a color closest to the skin color when Example 7 is compared with Example 6.

As has been described above, we have found out that, through the simulations, the appearance of color vision correction lens 1 or 201 can be improved by providing reflective layer 20, 120, or 220. In addition, we have considered an influence on user 90, or in other words, an influence on a color vision correction function caused by providing reflective layer 20, 120, or 220.

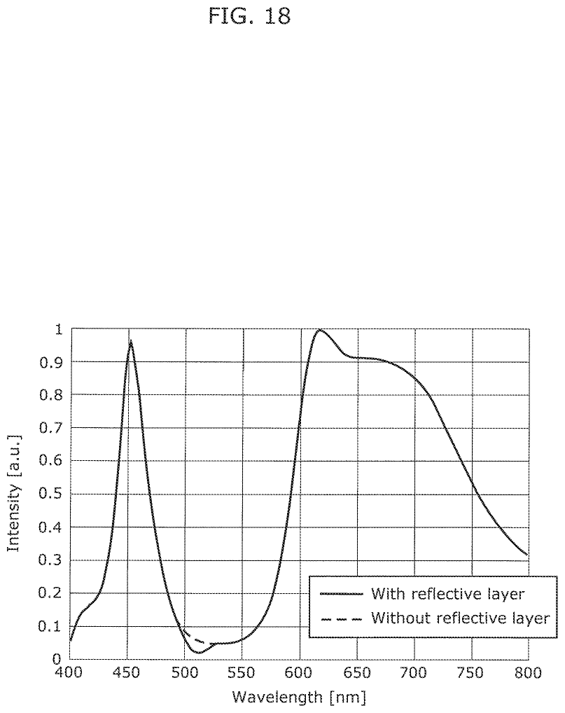

FIG. 18 is a diagram illustrating a result obtained by simulating an optical property of color vision correction lens 1 or 201. In FIG. 18, the horizontal axis represents a wavelength (unit: nm), and the vertical axis represents the intensity of light (unit is arbitrary). The intensity of light is the intensity of light that can be received on the resin layer 10 side of color vision correction lens 1 or 201, or in other words, the intensity of light which enters an eye of user 90.

In comparison with the case in which reflective layer 20, 120, or 220 is not provided, the intensity of light is decreased at the wavelength of around 510 nm when reflective layer 20, 120, or 220 is provided as illustrated in FIG. 18. Except for the decrease, there is no difference in the intensity of light between the case in which reflective layer 20, 120, or 220 is provided and the case in which reflective layer 20, 120, or 220 is not provided. Accordingly, color vision correction lens 1 or 201 can appropriately correct color vision of user 90 with or without reflective layer 20, 120, or 220.

As has been described above, in color vision correction lens 1 or 201, the peak wavelength of the second wavelength band which is the reflection range of light reflected by reflective layer 20, 120, or 220 is in the range in which the CIE 1931 chromaticity coordinates (x1, y1) are shifted toward white (white region 303). The CIE 1931 chromaticity coordinates are obtained from a reflection spectrum which is obtained by multiplying the spectral reflectance of human skin and the spectral absorptance of resin layer 10.

With this, it: is possible to realize color vision correction lens 1 or 201 having an appearance with reduced sense of oddness while ensuring a color vision correction function.

The color vision correction lenses and the optical components according to the present disclosure have been described as above based on the embodiments; however, the present disclosure is not limited to the aforementioned embodiments.

For example, the inclusion relation between light in the first wavelength band which resin layer 10 absorbs and light in the second wavelength band which reflective layer 20 reflects is not particularly limited. The second wavelength band may completely include first wavelength band, for example. The lower limit of the first wavelength band may be less than the lower limit of the second wavelength band, and may be greater than or equal to the lower limit of the second wavelength band. The upper limit of the first wavelength band may be greater than the upper limit of the second wavelength band, and may be less than or equal to the upper limit of the second wavelength band. In addition, the first wavelength band and the second wavelength band may be completely the same. Furthermore, the width of the first wavelength band may be narrower than or equal to the width of the second wavelength band.

In addition, the peak reflectance of reflective layer 20 or 120 may be greater than 99%, and may even be 100%, for example. In addition, the peak reflectance of reflective layer 20 or 120 may be less than 10%.

Furthermore, light in the first wavelength band which resin layer 10 of color vision correction lens 1 absorbs and light in the second wavelength band which reflective layer 20 or 120 reflects need not be the green wavelength band. The first wavelength band and the second wavelength band each may be a wavelength band suitable for color vision correction lens 1 to balance the color vision.

Moreover, resin layer 10 of color vision correction lens 1 may be a flat plate. Specifically, each of the first surface of resin layer 10 which faces user 90 and the second surface on an opposite side of the first surface may have a flat surface. In addition, the second surface of resin layer 10 may have a concave surface.

The present disclosure also encompasses: embodiments achieved by applying various modifications conceivable to those skilled in the art to each embodiment; and embodiments achieved by optionally combining the structural elements and the functions of each embodiment without departing from the essence of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A color vision correction lens that corrects color vision of a user, the color vision correction lens comprising:
a resin layer having a first surface facing an eye of the user and a second surface on an opposite side of the first surface; and
a reflective layer on a second surface side of the resin layer, wherein
the resin layer contains a color material which selectively absorbs light in a first wavelength band,
the reflective layer selectively reflects light in a second wavelength band, and
the first wavelength band and the second wavelength band overlap at least partially.

2. The color vision correction lens according to claim 1, wherein
the reflective layer is disposed on the second surface.

3. The color vision correction lens according to claim 1, wherein
in a plan view of the second surface, the reflective layer is movable to a position at which the reflective layer covers the second surface and to a position at which the reflective layer does not cover the second surface.

4. The color vision correction lens according to claim 1, wherein
the second wavelength band is included in a range of at least 500 nm and at most 570 nm.

5. The color vision correction lens according to claim 4, wherein
a peak wavelength of the second wavelength band is included in a range in which CIE 1931 chromaticity coordinates are shifted toward white, the CIE 1931 chromaticity coordinates being obtained from a reflection spectrum obtained by multiplying spectral reflectance of human skin and spectral absorptance of the resin layer.

6. The color vision correction lens according to claim 1, wherein
a peak reflectance of the reflective layer is at least 10% and at most 99%.

7. The color vision correction lens according to claim 1, wherein
the second wavelength band is narrower than the first wavelength band, and is entirely included in the first wavelength band.

8. The color vision correction lens according to claim 1, wherein
the reflective layer includes a colloidal crystal structure.

9. An optical component, comprising:
the color vision correction lens according to claim 1.

10. The optical component according to claim 9, wherein
the optical component is one of a pair of eyeglasses, a contact lens, an intraocular lens, and a pair of goggles.
